(19) United States
(12) Patent Application Publication
(10) Pub. No.: US 2026/0364434 A1
(43) Pub. Date: Nov. 19, 2026

(54) Artificial Intelligence-Assisted Adjudication and Augmented Reality Visualization Framework for Competitive Sport

(71) Applicant: Exadreams LLC, Frisco, TX (US)

(72) Inventors: Sarath C. Panchanathan, Frisco, TX (US); Vijayalakshmi Annadurai, Frisco, TX (US)

(21) Appl. No.: 19/678,610

(22) Filed: May 15, 2026

Related U.S. Application Data
(60) Provisional application No. 63/808,573, filed on May 19, 2025.
(60) Provisional application No. 63/809,455, filed on May 21, 2025.
(60) Provisional application No. 63/810,750, filed on May 23, 2025.
(60) Provisional application No. 63/810,754, filed on May 23, 2025.
(60) Provisional application No. 63/811,905, filed on May 25, 2025.
(60) Provisional application No. 63/811,917, filed on May 26, 2025.
(60) Provisional application No. 63/811,930, filed on May 26, 2025.
(60) Provisional application No. 63/816,805, filed on Jun. 3, 2025.
(60) Provisional application No. 63/847,407, filed on Jul. 20, 2025.
(60) Provisional application No. 63/847,410, filed on Jul. 20, 2025.
(60) Provisional application No. 63/847,415, filed on Jul. 20, 2025.

(51) Int. Cl. A63B 71/06; G06T 19/00; G06V 10/764; G06V 20/40

(52) U.S. Cl. CPC A63B 71/0669; G06T 19/006; G06V 10/764; G06V 20/42; G06V 20/44

(57) ABSTRACT

Embodiments of the present disclosure include a system for artificial intelligence-assisted scoring, adjudication, and visualization for a sporting event, the system comprising: sensors coupled to a transmitter and to a competitor's uniform, body, or handheld implement; cameras configured to capture visual data; an edge computer coupled to an artificial intelligence resource, the edge computer configured to determine that a scoring event has occurred by: receiving the sensor data and visual data as data packets from the sensors and cameras; timestamping the data packets and correlating the timestamped data packets to determine a time of an event; executing discipline-specific scoring logic on the timestamped data packets; and transmitting the timestamped data packets to the artificial intelligence resource, which is configured to generate a scoring decision support machine-readable output data packet. A visualization system comprises the display device and an augmented reality resource, which is configured to generate an augmented reality overlay.

### CROSS REFERENCE TO RELATED APPLICATIONS

The present application claims the priority benefit of the following applications: U.S. Provisional Application No. 63/808,573, filed May 19, 2025, titled “Wireless Fencing Scoring and Validation Architecture for Competitive Fencing”; U.S. Provisional Application No. 63/809,455, filed May 21, 2025, titled “Weapon-Mounted Wireless Transmitter for Competitive Fencing”; U.S. Provisional Application No. 63/810,750, filed May 23, 2025, titled “Body-Mounted Contact Sensors for Wireless Scoring in Fencing (Sabre/Foil)”; U.S. Provisional Application No. 63/810,754, filed May 23, 2025, titled “Multi-Layer Filtering Logic for Reducing False Positives and Negatives in Wireless Fencing Scoring Systems”; U.S. Provisional Application No. 63/811,905, filed May 25, 2025, titled “Wireless Umpire Remote Control with Real-Time Scoring Override for Fencing Competitions”; U.S. Provisional Application No. 63/811,917, filed May 26, 2025, titled “Modular Charging Dock System for Wireless Fencing Scoring Equipment”; U.S. Provisional Application No. 63/811,930, filed May 26, 2025, titled “Mobile Application for Real-Time Match Management and Scoring Control in Fencing”; U.S. Provisional Application No. 63/816,805, filed Jun. 3, 2025, titled “Integrated Battery Power System for Wireless Fencing Gear”; U.S. Provisional Application No. 63/847,407, filed Jul. 20, 2025, titled “Visual Scoring Architecture for Competitive Fencing Using Motion Capture and Computer Vision”; U.S. Provisional Application No. 63/847,410, filed Jul. 20, 2025, titled “Artificial Intelligence-Based Scoring Decision Engine for Competitive Fencing”; and U.S. Provisional Application No. 63/847,415, filed Jul. 20, 2025, titled “Augmented Reality-Based Overlay System for Scoring Visualization in Competitive Fencing”. These applications are hereby incorporated by reference in their entirety, including all appendices.

### FIELD OF THE TECHNOLOGY

Embodiments of the disclosure relate to intelligent scoring systems for competitive contact sports, including, but not by limitation, to applications incorporating wireless sensing, sensor fusion, real time intelligent arbitration, computer vision, artificial intelligence, and augmented reality visualization.

### BACKGROUND

Competitive sports, such as fencing, often rely on electronic scoring systems that detect valid touches using devices such as continuity-based wired circuits, mechanical tip switches, conductive target surfaces, and reel-based tethering mechanisms. These devices present inherent technical limitations as bouts and matches accelerate, rule sets evolve, and expectations for transparency and reliability arise.

Traditional scoring systems depend on physical body cords and floor reels that create points of mechanical failure. Even momentary disruptions lead to scoring anomalies or system malfunction.

Arbitration and scoring in close-contact sports, such as fencing, generally require close visual observation from referees. This leads to a high rate of false positives and disputes as to points awarded. Close observation also presents a problem for spectators, who do not always immediately see why a point was awarded or how contact was made.

Existing wireless and electronic scoring systems, such as Favero FA-07, provide basic wireless continuity detection, but lack unified sensor fusion, edge computing, multi-layer filtering, arbitration assisted by Artificial Intelligence (AI), augmented reality visualization, and the ability to coexist with legacy scoring infrastructure.

Although attempts have been made to incorporate AI arbitration, such systems generally rely on limited inputs and serve as standalone tools and do not integrate with existing equipment or legacy systems. Additionally, these attempts generally do not include tamper-evident per-event audit trails, pre-bout fencer-weapon session binding, failover transparency logging, or gated dual-track deployment architecture.

Accordingly, a need exists for AI arbitration systems such as the systems described herein.

### SUMMARY OF EXAMPLE EMBODIMENTS

Embodiments of the present disclosure include a system for artificial intelligence-assisted scoring, adjudication, and visualization for a sporting event, the system comprising: a plurality of sensors, each of the plurality of sensors coupled to a transmitter and further coupled to a competitor's uniform, body, or handheld implement; a plurality of cameras configured to capture visual data from the sporting event; and an edge computer communicatively coupled to an artificial intelligence resource. The edge computer is configured to classify and log a scoring event by: receiving a first data packet from a plurality of sensors each of the plurality of sensors coupled to a transmitter and further coupled to a competitor's uniform, body, or handheld implement; verifying from the first data packet that a scoring event has occurred; receiving a second data packet from a plurality of cameras configured to capture visual data from the sporting event, the second data packet being received upon the verification that the scoring event has occurred; timestamping the data packets and correlating the timestamped data packets to determine a time of an event; executing discipline-specific scoring logic on the timestamped data packets; and transmitting the timestamped data packets to the artificial intelligence resource. The artificial intelligence resource configured to generate a scoring decision support output comprising a machine-readable output data packet transmitted to at least one display device coupled to the edge computer, the output data packet including a confidence score, a feature attribution trace, and a rule-code identifier. The system further includes a visualization system comprising the at least one display device and further comprising an augmented reality resource, the augmented reality resource configured to generate an augmented reality overlay and transmit the augmented reality overlay to the at least one display device.

In embodiments directed to competitive fencing, the handheld implement is generally one of: an épée, a foil, or a sabre. An implement sensor is generally positioned at the tip, blade, or guard. A body-coupled sensor is coupled to the lamé, mask, or other part of the competitor's uniform. In some embodiments, the body sensor comprises a resistive or inductive uniform or mask.

The artificial intelligence resource is trained on labeled datasets comprising synchronized video, sensor telemetry, and referee annotations that classify attack, parry, riposte, and counterattack, according to some embodiments.

The sensors, transmitters, cameras, edge computer, artificial intelligence resource, and augmented reality resource are coupled by wireless, wired, mesh, or other network. In various embodiments, the plurality of sensors, the plurality of cameras, the edge computer, the artificial intelligence resource, the augmented reality resource, and the at least one display device are communicatively coupled by way of a wireless communication system configured to transmit the data packets, the timestamped data packets, and the output data packets using at least one of: BLE 5.3, radio-frequency (RF) signaling, UWB, or Wi-Fi 6 protocols, and further configured to activate a fallback pathway in response to detecting a packet loss rate exceeding a defined threshold on a primary pathway.

According to some embodiments, the edge computer further applies multi-layer validation to the timestamped data packets, the multi-layer validation comprising hardware filtering, firmware filtering, and algorithmic filtering modules configured to reduce false-positive and false-negative scoring events, and logs detected invalid events for calibration feedback.

In some embodiments, the artificial intelligence resource is further configured to generate a structured analysis file upon the logging of the scoring event, the structured analysis file comprising a human-readable summary of the scoring event, the confidence score, the feature attribution trace, and the rule-code identifier.

Some embodiments include a competitor-implement binding mechanism. The competitor-implement binding mechanism is configured to associate a specific competitor's identity with a specific implement and sensor module coupled to the specific implement, the competitor-implement binding mechanism comprising a competitor-implement identifier. In various embodiments, the competitor-implement binding mechanism comprises any of: a radiofrequency identification token, a QR code scan, and a secure digital pairing handshake.

The artificial intelligence resource is further configured, in some embodiments, to generate an auditable bout decision record comprising a field for: a score value, a score timestamp, an applied rule reference, a unique audit identifier, the competitor-implement identifier, and a failover indicator flag set when a fallback pathway was used. A cryptographic hash for each of the fields is generated in the auditable bout decision record, according to some of these embodiments. In some embodiments, the auditable bout decision record is synchronized to a cloud synchronization module.

The augmented reality overlay, according to some embodiments, comprises a visual playback of the bout with an overlaid trace of any of: implement trajectory, timing window, implement contact with a competitor's body or uniform, off-target contact indicator, and competitor's bodily movement. The augmented reality overlay is generated at least in part by the artificial intelligence resource in order to allow for three-dimensional rotation and reflection of the visual playback.

Some embodiments of the system include an umpire remote control coupled by a wireless network to the edge computer, the umpire remote control configured to override a scoring decision by the artificial intelligence resource.

If the artificial intelligence resource is unable to resolve a possible conflict in received input data, or significant data is missing, the artificial intelligence resource will report a low confidence score. Accordingly in some embodiments, when the confidence score is below a predetermined threshold, the artificial intelligence resource queues the output data packet for human review.

Further embodiments of the system include one or more modular charging stations, each of the one or more charging stations having a charging interface configured to electrically couple with any of: the plurality of sensors, the plurality of cameras, the edge computer, and the umpire remote.

The system is configurable to be implemented with legacy scoring systems that register implement touches using electrical sensors, such as Favero models FA-05, FA-07, or FA-15; the St. George SG-11 and SG-12; and Allstar and Uhlmann systems, not exhaustively. In various embodiments, the edge computer is configurable to be operatively coupled with a legacy scorekeeping system as well as legacy sensors, such as floor reels connected to resistive or inductive uniforms. The legacy scoring system is further configured to receive an updated score from the edge computer upon the logging of a scoring event.

Further disclosed herein are methods for making, assembling, implementing, and using the systems described herein, as well as non-transitory computer-readable storage media having embodied thereon instructions which, when executed by a processor, perform the steps of the methods of implementing and using the systems disclosed herein.

### BRIEF DESCRIPTION OF THE DRAWINGS

While this technology is susceptible of embodiment in many different forms, there is illustrated in the drawings, and will herein be described in detail, several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It is further understood that several of the figures are merely schematic representations of the present technology. As such, some of the components may be distorted from their actual scale for pictorial clarity.

FIG. 1 illustrates an exemplary system for a legacy scoring system for competitive combat sports.

FIGS. 2A-2C illustrate examples of a scoring system integrating wireless edge processing and data tracks.

FIGS. 3A-3C illustrate examples of augmented reality overlays as produced by the systems and methods disclosed herein.

FIG. 4 diagrammatically illustrates an exemplary system scoring framework.

FIG. 5 diagrammatically illustrates an example system using weapon-mounted sensors having wireless transmitters.

FIG. 6 diagrammatically illustrates an example system using body-mounted sensors having wireless transmitters.

FIG. 7 illustrates an example of a modular charging dock system.

FIG. 8 diagrammatically illustrates an example of a multi-layer filtering pipeline for logging an event in the system.

FIG. 9 diagrammatically illustrates an example architecture for a wireless umpire remote.

FIG. 10 diagrammatically illustrates an example of a mobile application setup for use with the systems and methods herein.

FIG. 11 diagrammatically illustrates an example method for visual scoring.

FIG. 12 diagrammatically illustrates an example AI-assisted scoring arbitration process in further detail.

FIG. 13 diagrammatically illustrates an example of an augmented reality overlay system.

FIG. 14 illustrates an example method for maintaining an auditable bout decision record.

FIG. 15 illustrates an example method for pre-bout binding of metadata to a player and weapon used in a bout.

FIG. 16 illustrates an example end-to-end event flow and latency sequence from sensor touch detection to augmented reality renderings.

FIG. 17 depicts an exemplary deep neural network.

### DETAILED DESCRIPTION OF EXEMPLARY EMBODIMENTS

As used herein, the term “bout” refers to a regulated, scored combat between two competitors, such as two fencers. In a bout, players score points by striking the opponent's designated target area or by driving the opponent out of bounds.

“Strip” refers to the playing area for a competitive bout of fencing. While this term is used to refer to embodiments as used for fencing, other competitive floor sections and divisions are supported, such as boxing rings and combat mats.

“Auditable official bout decision record” as used herein refers to a structured data record produced per scoring event. The auditable official bout decision record generally comprises a score value, a microsecond-resolution timestamp, an applied rule reference, a unique audit identifier, a session binding identifier, a failover indicator flag, and a cryptographic hash of all preceding fields.

“Edge Scoring Processing Unit”, or ESPU, refers to a local compute device receiving wireless sensor inputs, applying filtering logic, executing scoring algorithms, generating auditable decision records, and transmitting results.

These definitions are not intended to be limiting, and alternative or expansive definitions should be understood where indicated by context.

It should be understood that, while examples are provided for use of these systems and methods in fencing, these systems and methods are usable in one-on-one contact sports in general. The example systems and methods described herein apply to fencing clubs, regional and national tournaments, International Fencing Federation (FIE) World Series events, and Olympic competition. However, the modular, affordable, and adaptable design accommodates regions with varying infrastructure. Beyond fencing, the inventive contributions—sensor fusion with tamper-evident audit trails, AI-assisted human-authority-preserving decision support, failover transparency logging, pre-session identity binding, and gated dual-track deployment—are applicable to kendo, taekwondo, and any officiating context requiring explainable, auditable, governance-compliant scoring.

The present disclosure provides an integrated, wireless, sensor-fusion scoring and governance-aligned validation framework for competitive one-on-one contact sports. The systems use two data tracks for scoring and arbitration of a match and for augmented reality visualization. The two data tracks generally comprise sensor data gathered from competitors and their equipment and video data gathered from one or more live video feeds.

The first data track comprises a pipeline for physical data, including data from sensors mounted on weapons (épée, foil, or sabre); body, uniform, or lamé-coupled target-area sensors; rechargeable power subsystems; and low-latency wireless communication channels coupled to an edge scoring processor. It should be noted that existing sensors, such as inductive lamés and masks, serve as examples of data inputs for the first data track as well.

In one example, the system notes that the sensor signal from player left arrived 0.5 milliseconds earlier than the signal from player right. A false-positive filter is applied to void a touch from player right, and the point is awarded to player left.

The second data track comprises a pipeline for video data collected from at least one, but generally a plurality, of video cameras. The cameras capture bout data, such as foot movement, blade speed and trajectory, and target zones in real time.

Both the first data track and the second data track are transmitted to an edge computer, such as an ESPU. The edge computer timestamps inputs and logs event data from the bout. One or more rules filters are applied to the data to determine whether a point has been scored, and by which competitor.

In various embodiments, the edge computer is communicatively coupled to a local edge server, which is in turn communicatively coupled to a cloud service. In various embodiments, the local edge server is further communicatively coupled to an augmented reality platform and to an artificial intelligence resource, such as a small language model, large language model, or other machine learning resource.

As used herein, the term “language model” generally refers to a probability distribution over a sequence of words. Language models generate probabilities by training on large and structured sets of text, also known as text corpora. A single text corpus may include a single language or many languages, and may have various levels of structure based on, for example, grammar, syntax, morphology, semantics, and pragmatics.

A Large Language Model, or LLM, refers to a language model consisting of a deep learning architecture that is trained on large quantities, often tens of gigabytes, of unlabeled text using self-supervised learning or semi-supervised learning to produce generalizable and adaptable output. The deep learning architecture may include a neural network with billions of weights or parameters. More detail regarding the use of neural networks will be outlined below. In some embodiments, the neural network may be a transformer, which uses a parallel multi-head attention mechanism, or alternatively the neural network may be recursive, operating in sequence.

A Small Language Model, or SLM, refers to an AI model capable of processing, understanding, and generating natural language content. SLMs are generally smaller in scale and scope than LLMs. Whereas an SLM generally includes a few million to a few billion parameters, an LLM may have hundreds of billions, or trillions. SLMs are generally more compact and efficient than LLM counterparts and thus require less memory and computational power.

A Generative Pre-Trained Transformer, or GPT, refers to a family of language models—generally LLMs—based on transformer deep learning architecture. GPT technologies can be used to power AI applications to generate text and images, analyze text and images, write code, process data, and more. These applications generally connect with the GPT through application programming interfaces (APIs), which allow them to pass data to and from the GPT.

The artificial intelligence resource generates recommendations based on data received from either or both of the two data tracks. According to preferred embodiments, the first data track encompasses authoritative scoring and validation data, whereas the second data track encompasses experience enhancement features, such as augmented reality overlays, coach analytics, and spectator visualization. In some embodiments, features from the second data track are conditionally activated upon verification of one or more of: scoring accuracy above a defined threshold across a minimum number of scored bouts; latency performance within system specifications; referee confidence scores above a defined acceptance threshold; and explicit governance or federation approval.

The recommendations are presented to a bout committee and any human referee. Each scoring event is recorded as part of an auditable official bout decision record. The auditable official bout decision record is tamper-evident and can be used for reference in the event that a scoring event is challenged or appealed.

In some embodiments, the ESPU functions as a read-only observer that receives and logs sensor data, applies filtering logic, and generates auditable decision records. In such read-only embodiments, legacy scoring devices may still be used.

Scoring event data is obtained using data determined from the following categories, according to various embodiments:
Touch and electrical events—Contact on/off states and durations as determined from weapon-coupled or uniform-coupled sensors, such as inductive lames. Contact states further include on target/off target indications and weapon-specific signals for épée, foil, and sabre.
Motion and kinematics—Blade speed, blade acceleration or deceleration, direction of movement, angle of contact, and body motion (advance, retreat, lunge). Motion and kinematics, in various embodiments, are measured using inertial measurement devices (IMUs) and other motion sensors.
Visual context data—Time-aligned video frames, multi-angle capture, and frame-accurate event markers for video correlation.
Bout and match metadata—Weapon and discipline identifier, strip identifier, competitor mapping, score at time of action, period and time remaining, and priority or right of way state.
Player and equipment association data—Athlete ID (International Fencing Federation or national), weapon user identification, and equipment validation status.
System health and integrity data—Sensor health status, battery levels, signal quality, packet loss rates, latency measurements.
Time synchronization data—Time delta between multiple touch signals, sensor-to-sensor synchronization, and sensor-to-video alignment timestamps.

In general, preferred embodiments first capture reliable time-synchronized signals. AI inference and visualization follow only after validated data is available. Accordingly, every scoring decision is traceable to auditable evidence.

In embodiments incorporating weapon-mounted wireless transmitters, the wireless transmitters integrate with the weapon near the handle or guard. Example transmitters use low-power microcontroller units (MCUs), such as Nordic nRF5340, with Bluetooth Low Energy and, in some embodiments, proprietary radiofrequencies (RFs). Example sensors include pressure sensors (épée or foil tip), capacitive or conductive-contact sensors (sabre), and, in some embodiments, an IMU for blade trajectory inference.

Various embodiments include a wireless subsystem with sub-10 millisecond latency and frequency hopping; a 500 mAh rechargeable lithium-ion polymer (Li-Po) battery with built-in battery management system (BMS), USB-C charging, and, in some embodiments, inductive charging; and IP-rated lightweight housing. Alternative power sources include supercapacitors for ultra-fast charging or kinetic energy harvesting.

In embodiments incorporating body-mounted contact sensors, the wireless sensors are integrated into lamé jackets, masks, and gloves detect valid target-area contact. Sensor types include capacitive touch grids, resistive contact pads, conductive fabric meshes, and, in some embodiments, optical sensors.

Example configurations include sewn-in flexible printed circuit boards (PCBs), magnetic snap-on detachable modules, and washable detachable configurations designed in anticipation of FCC and CE compliance for wireless sporting equipment. Each sensor module transmits contact location, duration, player identification, sensor health, and microsecond-resolution timestamps.

The sensors are communicatively coupled to an edge computer, such as an ESPU. The ESPU serves as the central computational hub and executes: packet decryption and parsing; microsecond-level timestamp assignment; discipline-specific scoring logic (epee simultaneous touches, foil target area and right-of-way, sabre blade contact and lockout); multi-layer validation; and auditable official bout decision record generation. Hardware includes a high-performance embedded compute module, such as Raspberry Pi CM4, NVIDIA Jetson Nano/Xavier, or Google Coral Edge TPU.

In various embodiments, the ESPU is further communicatively coupled to a local edge server. Data are synchronized to the local edge server for tournament reporting and backup. If the edge computing unit fails, the local edge server functions as the edge computing unit, allowing the match to continue seamlessly.

An example of a method for multi-layer validation includes hardware filtering, firmware filtering, and algorithmic filtering. Hardware filtering generally includes low-pass filters, debounce circuitry, noise suppression, and contact threshold shaping to prevent micro-vibrations and tip chatter from registering as valid hits. Firmware filtering generally comprises adaptive timing thresholds based on bout tempo, minimum contact duration enforcement, multi-sample confirmation windows, and sensor fusion. Invalid events are logged for calibration feedback. Algorithmic validation generally includes sequence logic, discipline rules (foil/sabre right-of-way, off-target detection, simultaneous touch thresholds), and contextual filtering verifying that touches have occurred within valid scoring sequences and timing windows.

When the primary BLE pathway encounters signal degradation exceeding defined thresholds, the system activates a fallback RF pathway and sets the failover indicator flag in the corresponding auditable decision record. This flag is visible in referee consoles and governance dashboards, ensuring complete transparency in contested calls.

The system incorporates high-speed cameras, generally at corners of a combat strip. The high-speed cameras generally capture motion in the range of 120-240 frames per second. Accordingly, the pipeline executes: pose estimation generating 2D and 3D skeletal landmarks; weapon trajectory reconstruction; collision detection against valid scoring zones; target area classification; priority interpretation for foil and sabre; and event timestamping synchronized to the master scoring timeline. Wearable markers or tracking suits assist skeletal motion tracking. Frame-accurate replay with annotated key frames is available for referee review of disputed events.

In various embodiments, the AI resource generates decision support for referees and bout committees. The engine comprises: a rules-based module implementing versioned FIE and national federation rule sets; a machine-learning module trained on labeled datasets (synchronized video, sensor telemetry, and referee annotations from international competitions) classifying attack, parry, riposte, and counterattack at 60-240 Hz; and a conflict-resolution module combining all inputs into a unified recommendation with confidence score. An explainability module provides feature attribution maps and hit justification logs.

AI outputs are recommendations for human referee review. Generally, the ESPU routes the AI recommendation to the referee console and awaits referee confirmation before logging the official score.

In various embodiments, the AI resource supports federation-specific fine-tuning for national rule-set variations. Machine learning (ML) model updates are deployed via the OTA update system. Deployment configurations include edge-only, cloud-only, and hybrid edge-cloud.

In various embodiments, an augmented reality subsystem renders role-specific overlays. Camera feeds are transmitted to the augmented reality resource by way of the edge computing unit and local edge server. The process insights are directed back to the edge computer for umpire review, spectator overlay, and live broadcast. Various modes are supported.

Referee Mode displays hit location, blade trajectory trails, timing windows, and annotated slow-motion replay. Spectator Mode, in various embodiments, includes animated scoring lights and hit probability displays. Broadcast Mode provides virtual blade tracers, heat maps, and streaming platform export with color-coded weapon trails and off target contact indicators.

Various embodiments of the system include a wireless umpire remote in communication with the edge computer. The wireless umpire remote enables referees to override scoring decisions, manage match flow, and select fencing styles. Example hardware for the wireless umpire remote includes an ESP32-S3 MCU, physical override controls, status display, and rechargeable battery. Override actions are logged to the auditable decision record with timestamp, referee identifier, and original versus corrected score. In various embodiments, voice-activated scoring control via wake-word engine and natural-language command parser are supported as input modes. Multi-strip channel assignment enables one remote to manage a specific strip within a multi-strip tournament environment.

One or more mobile applications are provided, in various embodiments. In one example, the mobile application provides match control (start/pause/reset/discipline selection), real-time scoring display, umpire override mode with audit logging, spectator interface with historical data, tournament management (strip assignment, device readiness, match log export), and an anti-tampering module. The anti-tampering module uses cryptographic log chaining or blockchain-based verification for immutable bout records. In some embodiments, AI-generated performance insights and AR overlay are presented in the mobile application.

The systems and methods described herein are designed to be integrated or retrofitted in existing platforms. An example of a method for retrofitting comprises phased integration. In a first phase, a wireless sensor network is communicatively coupled with an ESPU that operates in parallel with a legacy scoring machine. The ESPU receives sensor data, applies validation, and generates auditable records, while the legacy machine continues its existing scoring functions. In general, according to this phased input, neither the ESPU nor any system component overrides or modifies the legacy machine's outputs in this first phase. Progressive migration from legacy to ESPU scoring authority occurs upon satisfaction of defined accuracy and governance criteria at each phase.

In various embodiments, each device uses 3.7 V lithium-ion polymer (Li-Po) or lithium-ion battery with overcurrent and thermal protection, auto-sleep below 1 milliampere idle current, and motion or contact-triggered wake. Example charging interfaces include: USB-C, magnetic pogo-pin dock contacts, and in some embodiments, and Qi wireless coil. A boost converter delivers stable regulated output. In preferred embodiments, the modular charging dock simultaneously charges multiple devices and, in some embodiments, comprises a daisy-chain expansion port for tournament-scale deployment. In some embodiments, the charging dock reports device readiness to a mobile app. Solar-powered dock variants support outdoor or mobile tournaments.

According to various embodiments, over-the-air (OTA) update architecture distributes cryptographically signed update packages through cloud, local area network (LAN), and wireless pathways to all system components. Updates include firmware for sensor modules, software for scoring and AI logic, and ML model refreshes for rule-set transitions. ESPUs apply updates in off-bout windows without interrupting active matches. Device attestation, version control, rollback capability, and fail-safe mode are included.

In various embodiments, processed insights are directly accessed from cloud services via registered interfaces and mobile applications.

Embodiments of the present disclosure further support assessment platforms for competitors. The assessment platforms triangulate perspectives from coach, competitor, and competitor's support team.

An example system for an assessment platform is built on a serverless architecture using a relational cloud database backend, a static frontend deployed via edge network, serverless API functions, and AI model inference provided through external AI APIs. The AI APIs generally connect to commercially available language models or, in some embodiments, to proprietary, special purpose language models.

In various embodiments, the system collects independent performance inputs from the competitor, the coach, and the competitor's support team, which may include parents, representatives, advisors, and others who work closely with and on behalf of the competitor.

According to one example, a plurality of performance categories, or dimensions, are assessed. For fencing, example categories include technical performance, tactical performance, fitness, mental performance, discipline, support, and nutrition. Technical performance includes bladework, footwork, point control, and distance management. Tactical performance includes strip tactics, pattern recognition, bout strategy, and adaptability. Fitness generally includes endurance, speed, agility, strength, and physical conditioning.

Mental performance generally includes focus, pressure handling, confidence, and emotional control. Discipline includes practice habits, consistency, goal setting, and time management. Support includes coaching access, family support, training environment, and resources. Nutrition includes diet quality, hydration, recovery fuel, and competition nutrition.

Data packets are received for each of the seven categories. The data packets generally include historic data from scoring events from one or more bouts as logged by the system, as well as user-submitted data. User-submitted data is generally submitted by competitors, their supporters, or their coaches. An example of user-submitted data includes a self-assessment. The self-assessment is formatted as any of: Likert-scale ratings, multiple-choice selections, and open-ended text fields with structured categories, or any combination of these. In various embodiments, the self-assessments are made available upon signup and updated or reassessed periodically, such as every 30 days.

Once the data is received, the edge computer scores all seven dimensions according to a rules-based scoring system. According to an example method, for each dimension, the weighted average of the plurality of perspective inputs is computed. An overall Development Index is computed as the weighted average of all seven-dimensional scores, with optional secondary weighting by coach perspective for dimensions where professional evaluation is most authoritative, such as Technical or Coach Evaluation. The resulting Composite Development Profile includes: Individual dimensional scores (0-10 scale); Overall Development Index (0-10 scale); Perspective-specific sub-scores per dimension; Strongest dimension identification; Priority development area identification (weakest dimensions); Developmental level classification (Beginner, Intermediate, Advanced, Advanced Competitive, Elite/International); and Progression indicators relative to prior assessment cycles.

In some embodiments directed to fencing, weapon-specific weighting coefficients are applied to each dimension's contribution to the composite score. By way of example:

Sabre competitors receive higher weighting on speed, explosive power, and tactical right-of-way decision-making. The Physical Conditioning and Tactical dimensions carry elevated weight relative to foil and épée.

Foil competitors receive higher weighting on precision, point control, and right-of-way rule application. The Technical dimension carries elevated weight with emphasis on targeting accuracy.

Épée competitors receive higher weighting on timing, distance management, and strategic patience. Tactical and Mental Performance dimensions carry elevated weight, reflecting the importance of calculated risk management in an all-target weapon.

Weighting coefficients are applied at the dimension level, such that the same raw perspective input scores produce different composite dimensional profiles for athletes of different weapon disciplines, accurately reflecting the weapon-appropriate developmental priorities.

The artificial intelligence resource weighs gaps and priorities and prepares a human-readable output. An example of human-readable output includes a longitudinal development plan or 90-day growth roadmap. Training sessions according to the development plan or growth roadmap are calibrated to target the competitor's weak categories. The competitor and their support team track and iteratively log new input data. The system then reassesses according to the iterative inputs.

Training plan generation generally uses the athlete's dimensional score profile as the primary input, with secondary inputs including: competition calendar and upcoming tournament targets; training history and prior drill completion rates; coach-specified training priorities; athlete-stated goals and preferences; and physical profile data (height, weight, age category) where provided. In various embodiments, the AI resource generates plans that front-load drills targeting the athlete's lowest-scoring dimensions while maintaining technical foundation work throughout the plan duration.

In some embodiments, the platform maintains a drill library. An example drill library has three source categories: Built-In drills, which are pre-loaded by the platform; Custom drills, created by coaches for their specific athletes; and AI-generated drills, dynamically created by the AI resource for specific skill gaps. Drills are tagged by weapon, dimension, difficulty level, session duration, and equipment requirements. The training planner provides per-drill completion tracking with status states: Pending, Done, Skipped, and Deferred.

According to some embodiments, self-assessments are a static set of questions in a first iteration. In further iterations, questions on the self-assessment are dynamically generated by the artificial intelligence resource according to the competitor's progress in the various categories. By way of example, in a first iteration, all questions are static; in a second iteration, approximately half of the questions are static, with the remaining half being generated by the artificial intelligence resource; in a third iteration, approximately 70% of questions are generated by the artificial intelligence resource. After multiple iterations, the assessment is substantially personalized to the competitor's development trajectory.

In some embodiments, players and their support teams use a goal-driven assessment mode, whereby the system presents questions that are tailored to a specific goal, such as a target tournament, opponent's known tendencies, target rating advancement, or other competitive objectives. The system generates a customized assessment battery focused on the specific skills and categories most relevant to achieving the stated goal.

In some embodiments, the artificial intelligence resource uses a pattern recognition subsystem with journal sentiment analysis, drill completion records, and performance trends to detect burnout risk, training plateaus, and high-impact drill patterns. Signals include: negative sentiment trends in journal entries, declining training session completion rates, increasing “skipped” drill counts, reduced training frequency, and negative language patterns related to motivation and enjoyment. When burnout risk signals are detected, the system generates wellbeing alerts visible to coaches and parents (for under-18 athletes) and adjusts training plan intensity recommendations accordingly.

The system identifies which drills are most closely correlated with improvement across which dimensions; signals of burnout risk from sentiment degradation and training volume patterns; and plateau prediction based on flattening dimensional score trajectories.

Cohort benchmarking provides anonymized peer comparison within a competitive category, such as league or weapon type (épée, foil, or sabre), as well as completion level. Athletes may thus contextualize their own progress against that of similarly positioned athletes. Benchmarking outputs include: “Sabre fencers at your competition level average X. X in Tactical” type statements for each dimension, percentile ranking within cohort, and identification of dimensions where the athlete is above or below cohort average.

Benchmarking data is displayed with appropriate privacy protections and minimum cohort size thresholds to prevent individual identification.

According to some embodiments, the platform further includes supporting infrastructure including: a coaching marketplace with video review and coach discovery; a digital fencer identity and credential system linked to national federation membership; tournament check-in and live tracking; gear inventory and gear check modules; a club business operating system; and a fencer profile builder generating AI-verified recruitment documents for college athletics programs.

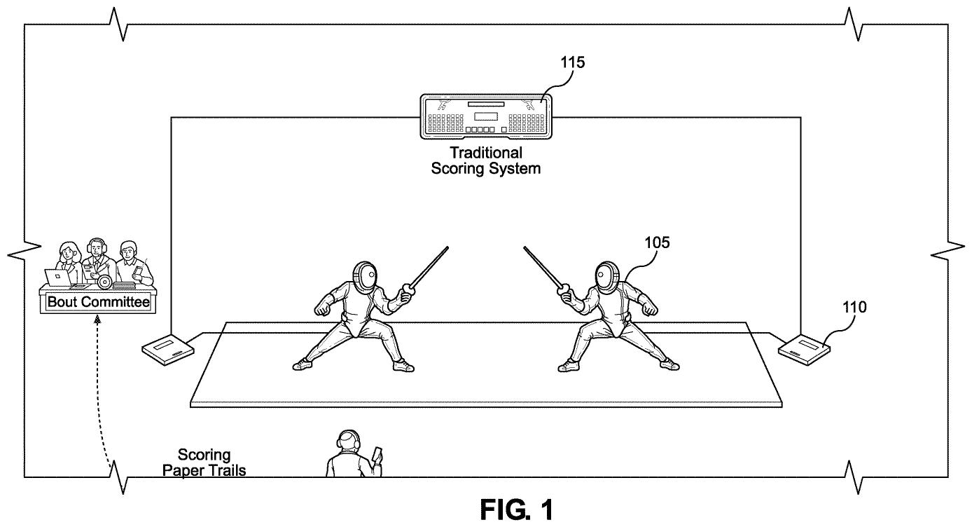

FIG. 1 diagrammatically depicts an example of a legacy scoring system for a one-to-one contact sport. Using the existing system, players wear sensory inputs, such as conductive lamés 105, that are connected by wire to a flow-reel 110, generally positioned on the floor outside the bout strip. The flow-reel 110 is communicatively coupled to an electronic scorekeeping system 115, which is generally an individual device that may be coupled to a wired or wireless network, not shown in FIG. 1.

The traditional electronic scorekeeping system 115 captures points scored, but generally no further details, such as player data or bout data. To capture player data and bout data, an umpire enters the information on a slip of paper, enters the players' names, and hands the slip of paper to the player who wins the bout or game. The slip of paper is then delivered to a bout committee, who enters the data into the online system. Only then does the data become available to wider audiences and coaches.

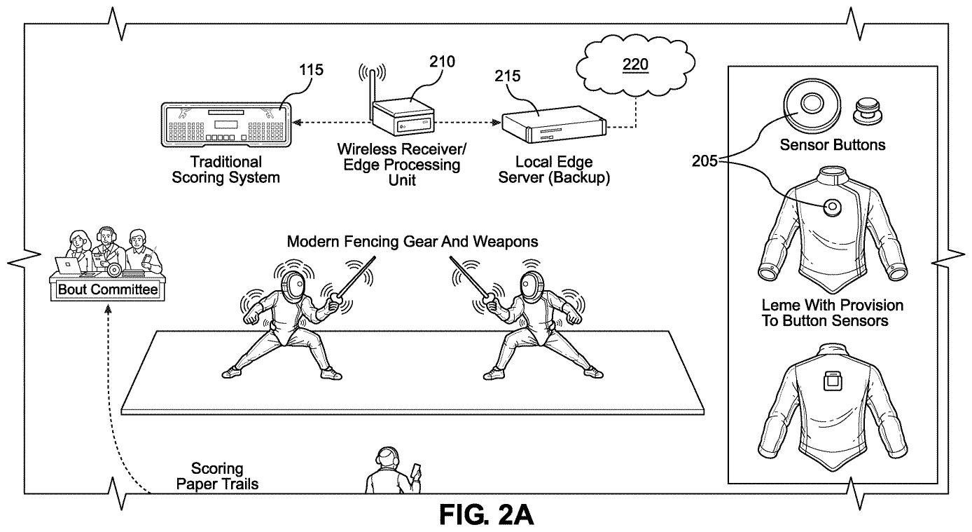

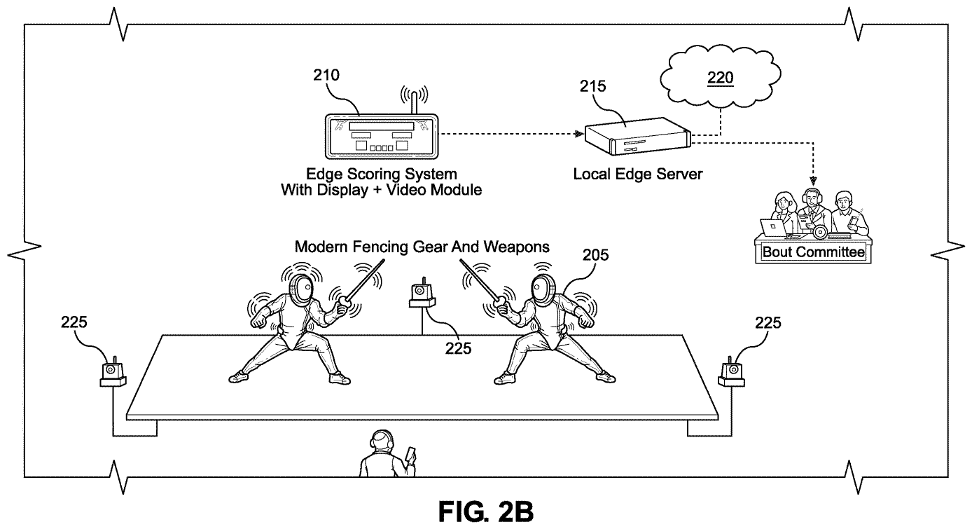

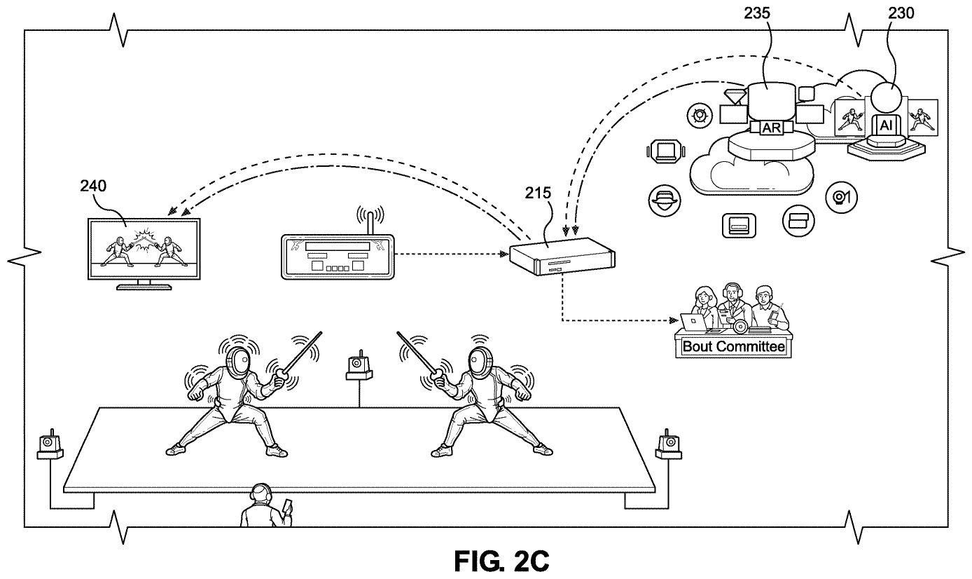

FIG. 2A diagrammatically depicts an example of a scoring system integrating wireless edge processing and a first data track with the legacy scoring system of FIG. 1. The example FIG. 2A introduces a first data track comprising sensor data from at least one sensor having a wireless transmitter 205. Conductive lames 105, face masks, and weapons are coupled with sensors having wireless transmitters 205 that transmit contact data to an edge processing unit 210. The edge processing unit 210 is communicatively coupled with the traditional electronic scorekeeping system 115 and, in various embodiments, is further communicatively coupled to a local edge server 215. The local edge server 215, in turn, is communicatively coupled to a cloud service 220, according to various embodiments.

FIG. 2B diagrammatically depicts a further example of a scoring system integrating wireless edge processing and a second data track. The example of FIG. 2B introduces a second data track comprising video data from at least one, but generally a plurality of cameras 225 positioned around the bout strip. The sensors having wireless transmitters 205 are used in conjunction with the plurality of cameras 225 to capture match data. The match data from both data tracks is transmitted to the edge processing unit 210, local edge server 215, and cloud service 220.

The traditional electronic scorekeeping system 115 is removed in the example of FIG. 2B, although it may still be used in conjunction with the system as shown in FIG. 2A.

FIG. 2C diagrammatically depicts a further example of a scoring system that further integrates an artificial intelligence resource for arbitration and augmented reality. In the example of FIG. 2C, the local edge server 215 is communicatively coupled to a cloud service that is in turn coupled with an artificial intelligence resource 230. The artificial intelligence resource 230 receives data from the first data track and the second data track and determines an outcome for the bout, the outcome generally comprising a decision on whether to award a point, to which player, and according to what rule or set of rules. The outcome is transmitted back to the local edge server 215 and delivered to the bout committee.

The local edge server 215 is further communicatively coupled to an augmented reality resource 235. The augmented reality resource 235 receives data from the first data track and second data track and uses artificial intelligence to generate a visualization of the bout. The visualization is transmitted to the local edge server 215 and delivered to a user interface 240 where the visualization is displayed as an augmented reality overlay.

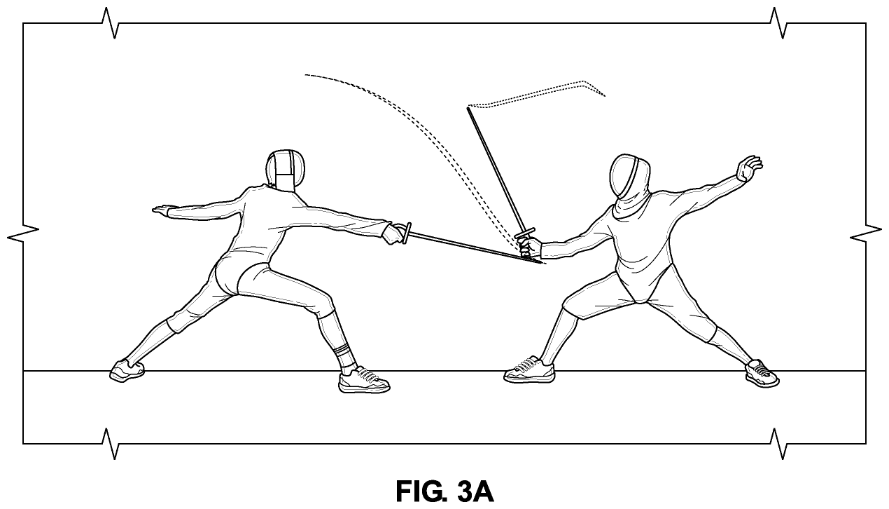

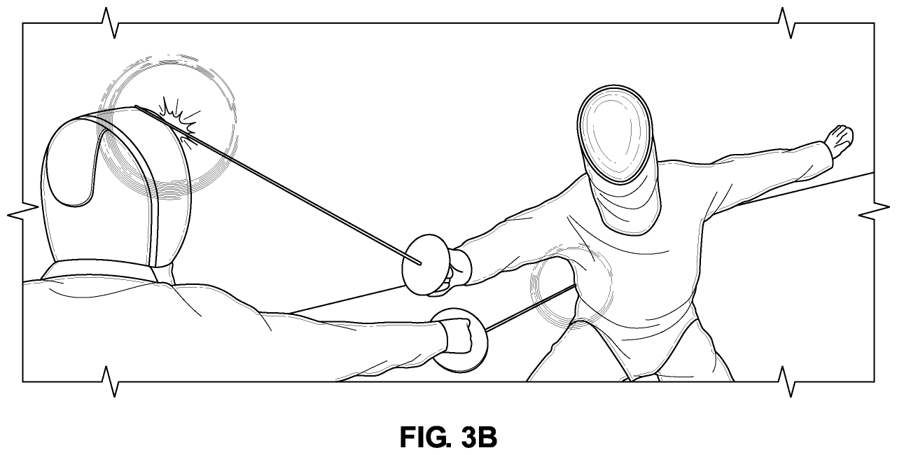

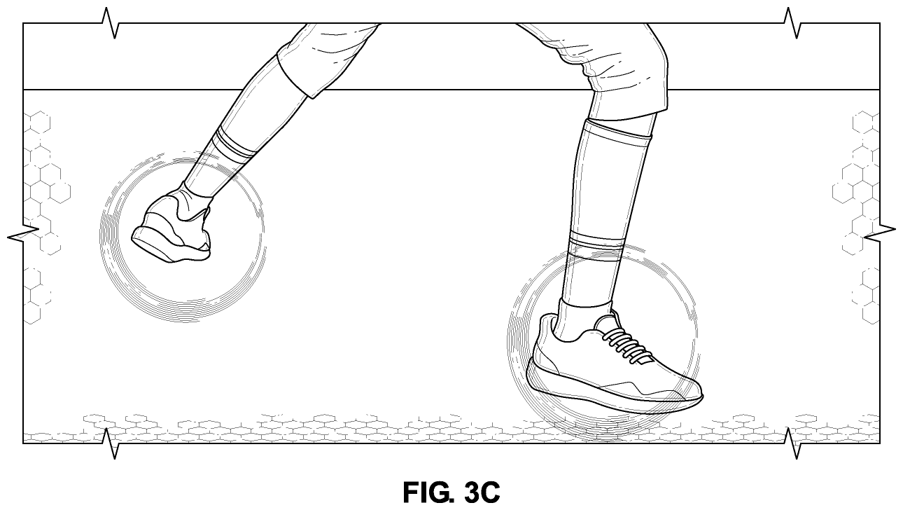

FIGS. 3A-3C illustrate examples of augmented reality overlays. FIG. 3A depicts an example of an augmented reality trace of weapon movement during a bout, here depicted in different colors to differentiate the opponents' blades. FIG. 3B depicts points of contact or strikes on an opponent with color-coded overlays. It should be noted that the view angle is adjustable and is generated using the second data track with generative artificial intelligence to fill in a view not captured by the plurality of cameras 225. FIG. 3C depicts foot movement with augmented reality overlay.

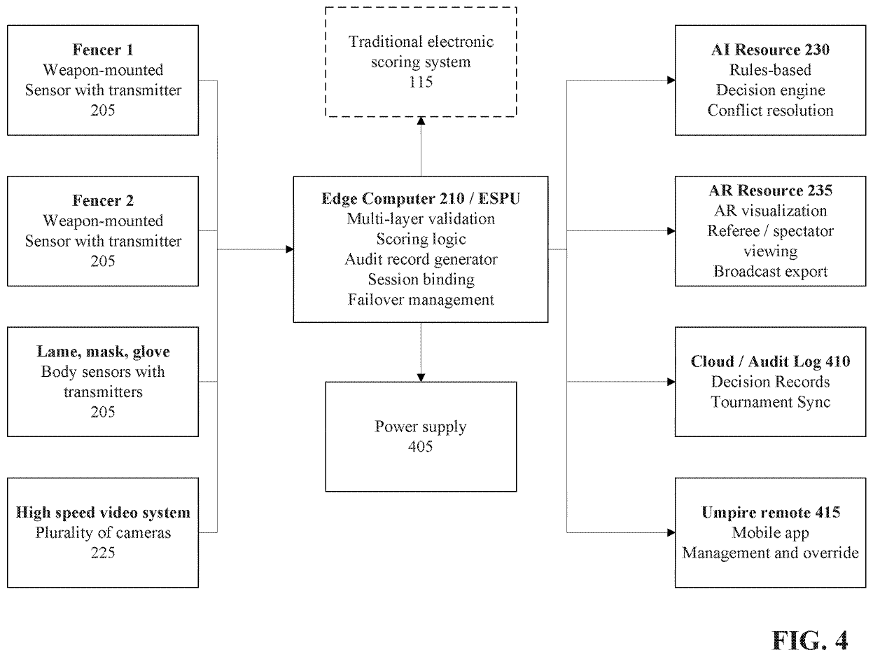

FIG. 4 diagrammatically illustrates an exemplary system scoring framework. A first data track is collected from sensors having transmitters 205 mounted on players' weapons and uniforms, and a second data track is collected from a plurality of cameras 225. The two data tracks are input into an edge computer 210. The edge computer 210 is generally rechargeable and couples to a power supply 405 and, in some embodiments, is coupled to a traditional electronic scorekeeping system 115. The edge computer 210 performs multilayer validation, scoring logic, audit record generation, session binding, and failover management.

The edge computer 210 is generally coupled with a local edge server 215, not shown in FIG. 4. The edge computer 210 is further coupled by way of the local edge server 215 to an artificial intelligence resource 230 and augmented reality resource 235. In various embodiments, the edge computer 210 is coupled to an audit log 410 for decision records and synchronization of tournament data. In various embodiments, the edge computer 210 is further coupled to an umpire remote 415 that is controlled by an umpire via mobile application or other device. The umpire remote 415 enables umpire management of decisions, including overrides.

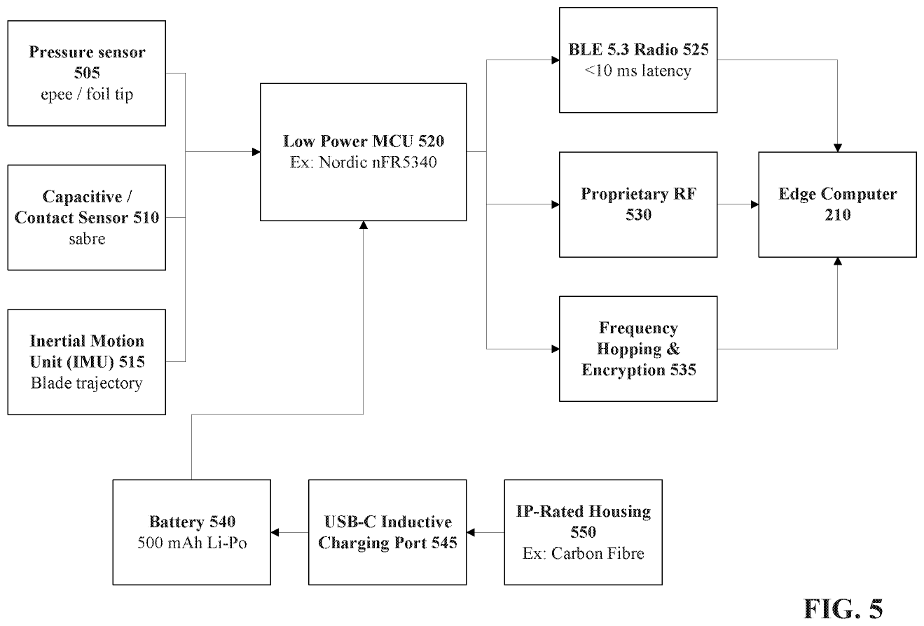

FIG. 5 diagrammatically illustrates an example system using weapon-mounted sensors having wireless transmitters 205. The weapon-mounted wireless transmitter is coupled with a pressure sensor 505 for épée or foil tip or a capacitive or contact sensor 510 for a sabre. The sensors further comprise an inertial motion unit (IMU) 515. The sensors are coupled to a low power MCU 520, such as a Nordic nFR5340. The MCU 520 is in turn coupled to a BLE radio 525 having low latency (below 10 milliseconds), as well as proprietary radiofrequency 530. In various embodiments, frequency hopping and encryption 535 are applied. The BLE and radiofrequency signals are in turn transmitted to the edge computer 210.

The MCU 520 is powered by a 500 mAh Li-Po battery 540. The battery is rechargeable by way of a USB-C inductive charging port 545 having IP-rated housing 550.

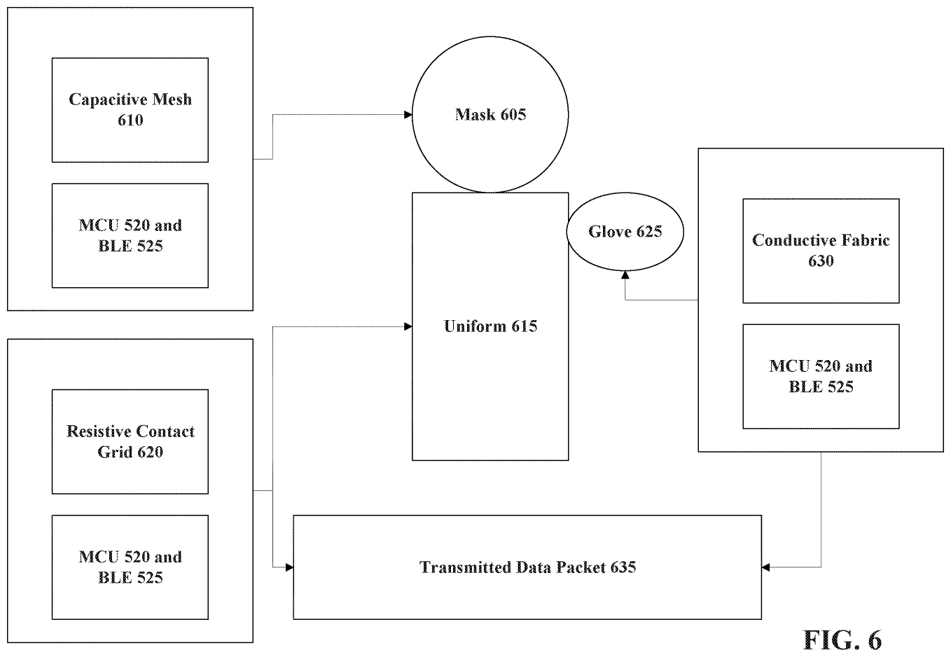

FIG. 6 diagrammatically illustrates an example system using body-mounted sensors having wireless transmitters 205. A competitor wears a mask 605 having a capacitive mesh 610 for conductive contact detection, a uniform 615 having a resistive contact grid 620, and one or more gloves 625 having conductive fabric 630. Detected contacts on each of the mask 605, uniform 615, and glove 625 are transmitted to an MCU 520 in each of the mounted sensors with transmitters 520 and in turn sent to the edge computer 210, here by BLE 525.

Each data packet 635 includes the contact data, as well as player identification, contact location, contact duration, timestamps, and sensor health. Each data packet 635 is generally transmitted on a per-event basis, such as when a contact is detected.

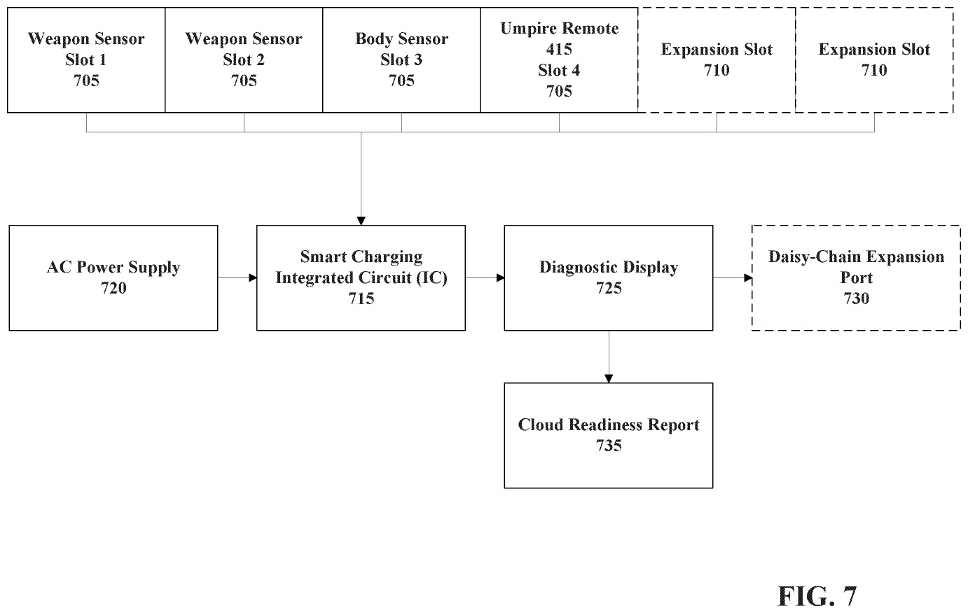

FIG. 7 illustrates an example of a modular charging dock system. The modular charging dock system includes a plurality of charging slots 705 for weapon-mounted and uniform-mounted sensors, as well as for the umpire remote 415. In various embodiments, expansion slots 710 are added or removed as needed to accommodate competitors, umpires, referees, and other users present for a match.

The plurality of charging slots 705, including any expansion slots 710, is coupled to a smart charging integrated circuit (IC) 715 powered by an AC power supply 720. In various embodiments, the modular charging dock comprises a diagnostic display 725 and one or more daisy-chain expansion ports 730. Embodiments of the modular charging dock are configured to transmit a cloud readiness report 735 to the cloud service 220 that one or more devices are charged and ready for use.

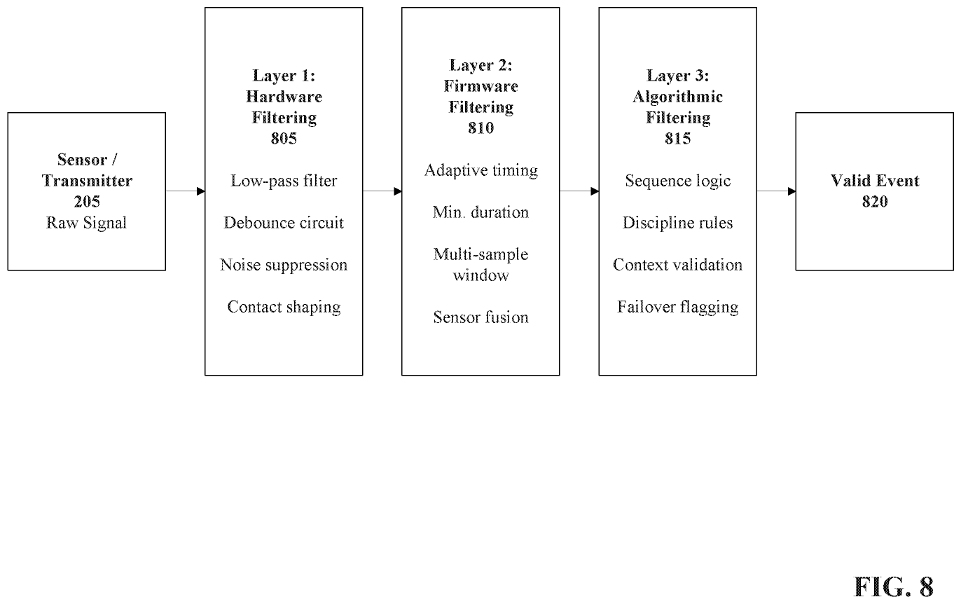

FIG. 8 diagrammatically illustrates an example of a multi-layer filtering pipeline for logging an event in the system. The edge computer 210 receives raw signal data from the sensors with transmitters 205 and applies three layers of filtering. First, hardware filtering 805 is applied. Hardware filtering generally comprises a low-pass filter, debounce circuit, noise suppression, contact shaping, and similar noise-reducing functions. Second, firmware filtering 810 is applied. Firmware filtering 810 generally comprises adaptive timing, minimum duration thresholds, multi-sample windows, and sensor fusion. Finally, algorithmic filtering 815 is applied. Algorithmic filtering 815 generally comprises sequence logic, discipline rules, context validation, failover flagging, and other rules-based applications to reduce false positives and determine the outcome of an event. A valid event 820 is then logged in the system.

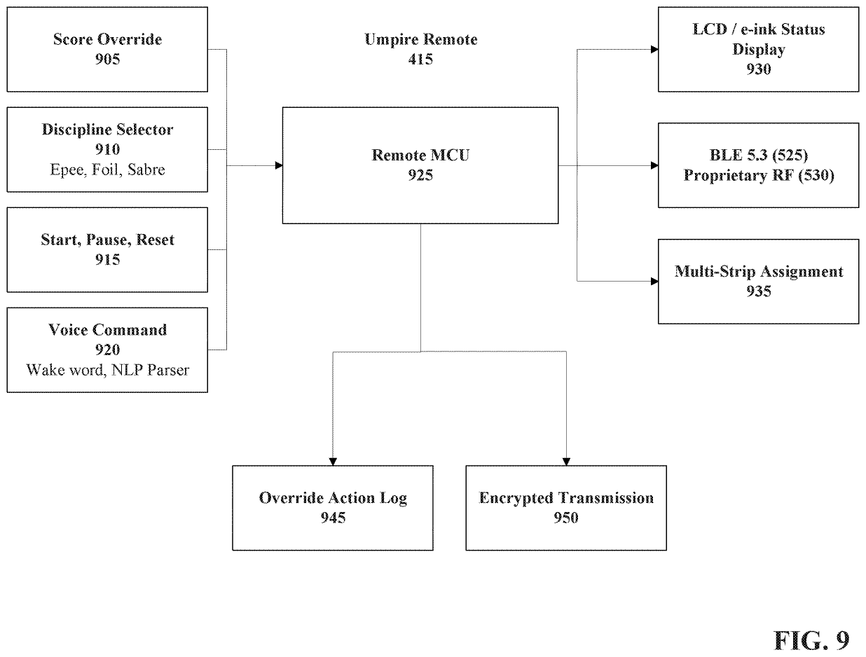

FIG. 9 diagrammatically illustrates an example architecture for a wireless umpire remote 415. Examples of control input features comprise score override 905; discipline selector 910; start, pause, reset 915; and voice command 920, which generally includes a wake word and a natural language processing parser. In various embodiments, the control inputs are received by a remote MCU 925 and transmitted to the edge computer 215 by BLE 5.3 525 or proprietary RF 530. In some embodiments, the umpire remote 415 includes an LCD or e-ink status display 930. Additionally, in some embodiments, the umpire remote 415 includes multi-strip assignment 935 to apply control input features to multiple bouts or matches at a time. In various embodiments, the remote MCU 925 is communicatively coupled with an override action log 945 and uses encrypted transmission 950.

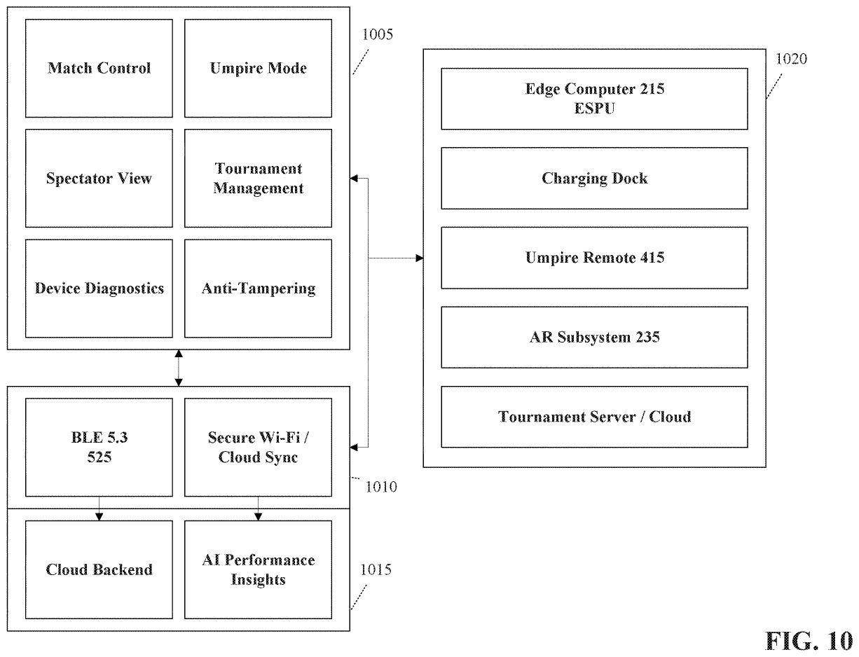

FIG. 10 diagrammatically illustrates an example of a mobile application setup for use with the systems and methods herein. The mobile application layer 1005 is coupled to a communication layer 1010, which is in turn coupled to a backend 1015. The mobile application layer is communicatively coupled to coupled subsystems 1020, which generally include the edge computer 215 or ESPU, charging dock, umpire remote 415, AR subsystems, and any tournament server or cloud. It should be noted that, in various embodiments, one tournament server is generally coupled to a plurality of edge computers 215 or ESPUs, each of which collect data for individual matches or match strips.

The mobile application layer 1005 generally comprises match control, such as start, pause, reset, and discipline select; spectator view, for live scores and visual overlays received from the AR subsystems; umpire mode, for score override and penalty and audit log; tournament management, such as strip assignment and device readiness; and device diagnostics, such as sensor health and battery and dock status. Device readiness is generally obtained from charging dock data. In various embodiments, the mobile application further includes anti-tampering technology, such as blockchain verification.

Mobile application data is transmitted by BLE 5.3 525 and, in various embodiments, by secured Wi-Fi for cloud synchronization. Various embodiments of the mobile application system include coupling the application to a backend 1015, such as a cloud backend. Some such embodiments include AI performance insights, which are returned to and displayed by the mobile application.

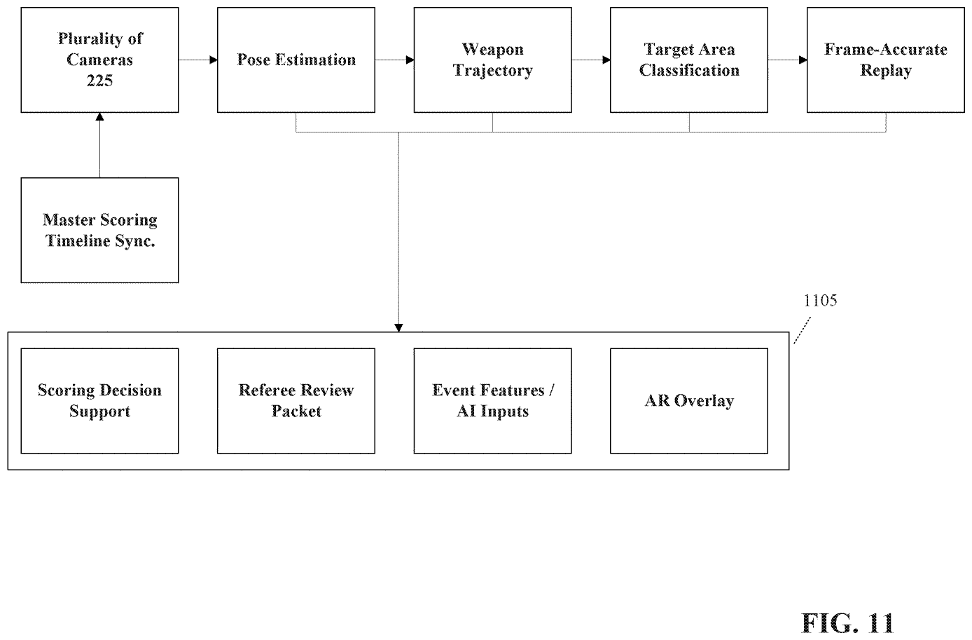

FIG. 11 diagrammatically illustrates an example method for visual scoring. Master scoring timeline synchronization is applied to data from the second data track as received from the plurality of cameras 215. Once the frames have been timestamped and correlated, the system executes pose estimation, weapon trajectory, and target area classification. Pose estimation is generally obtained from 2D frames, exoskeletal landmarks, and wearable markers. Weapon trajectory is reconstructed from blade path and point of contact, with various embodiments using Kalman and particle filters to minimize uncertainty. Target area classification is obtained from visual points of contact and sensor data. Various embodiments further incorporate frame-accurate replay for review, such as for disputed events.

Scoring outputs 1105 include scoring decision support, with confidence scoring and rule attribution; referee review packets, including key frames and generative pose annotations; and time-synced visual event features, which are delivered as AI inputs and used to generate the augmented reality overlay.

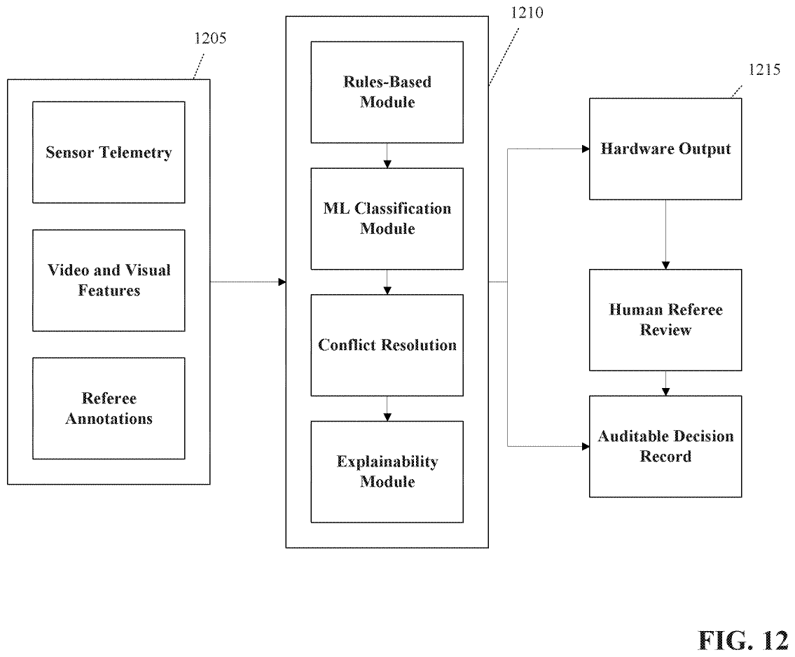

FIG. 12 diagrammatically illustrates an example AI-assisted scoring arbitration process in further detail. Assistant inputs 1205 include sensor telemetry, video and visual features from the plurality of cameras 215, and in some embodiments, referee annotations. The assistant inputs 1205 are entered into the assistant engine 1210 where a series of frameworks are applied: first, a rules-based analysis of the data, in which sport, federation, and tournament rules are applied; second, a machine learning classification model that identifies an action from the data, such as an attack, parry, riposte, or counterattack; third, a conflict resolution, which includes weighted aggregation and confidence score fusion; and an explainability module, which includes generative feature attribution maps and temporal attention windows. Outputs are delivered to a hardware output 1215 and queued for human referee review. In various embodiments, an auditable decision record is updated.

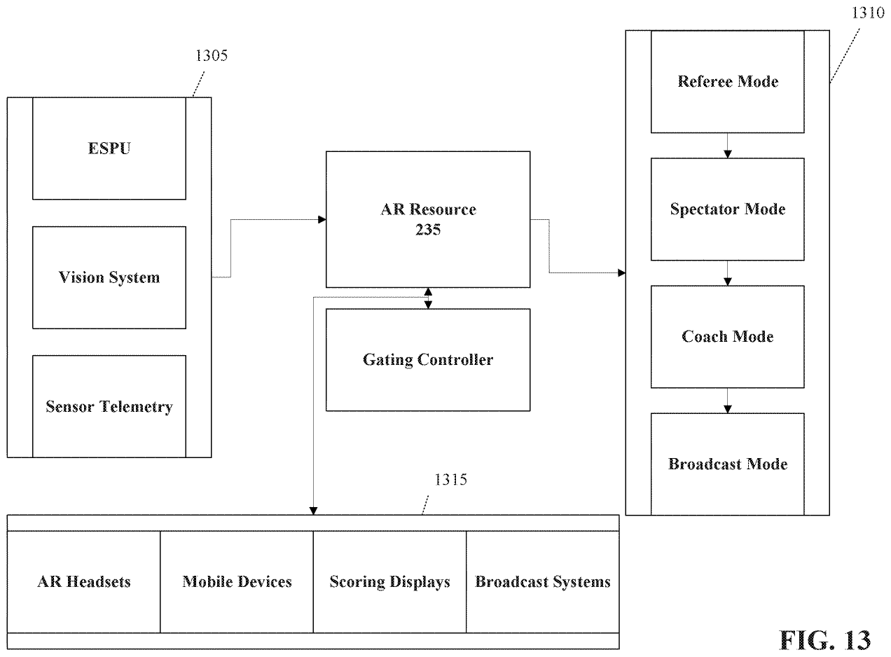

FIG. 13 diagrammatically illustrates an example of an augmented reality overlay system. The system comprises augmented reality inputs 1305 received from the ESPU or edge computer 215, vision system such as the visual scoring system of FIG. 11, and sensor telemetry from the sensors having transmitters 205. The augmented reality inputs 1305 are transmitted to the augmented reality resource 235, which renders blade trajectories, timing windows, target and off-target indicators, and color-coded trails in augmented reality. In some embodiments, the augmented reality resource is coupled with a gating controller that activates when data from the first data track is received.

Presentation modes 1310 for the augmented reality overlays include referee mode, spectator mode, coach mode, and broadcast mode. In referee mode, hit location and blade trail are displayed with annotated replay. Annotations are generated using the artificial intelligence resource. Spectator mode generally includes animated scoring lights and hit probability displays. Coach mode comprises motion analytics and pattern heatmaps. Broadcast mode includes virtual blade tracers and streaming platform export. AR devices 1315 coupled with the augmented reality resource 235 include AR headsets, mobile devices, scoring displays, and broadcast systems.

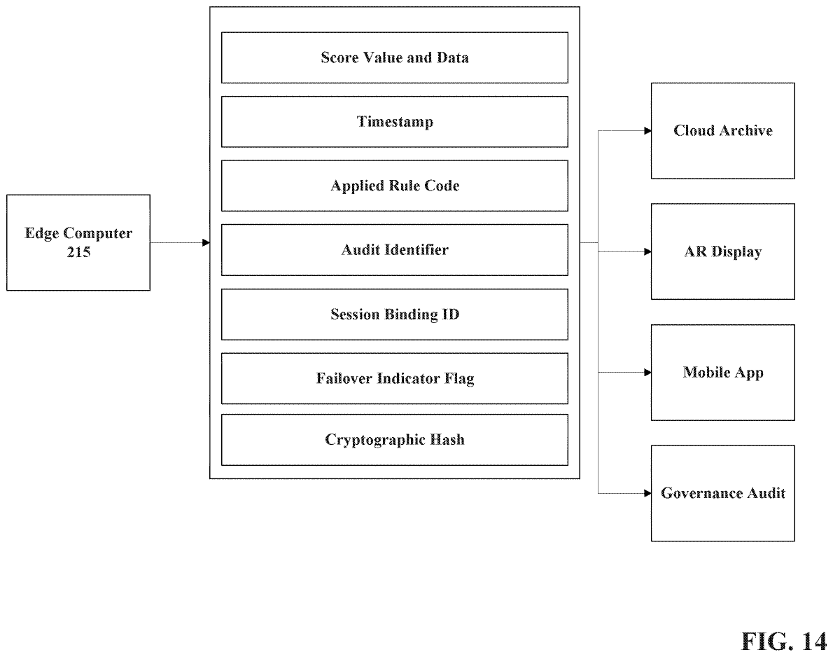

FIG. 14 illustrates an example method for maintaining an auditable bout decision record. Scoring data is received from the edge computer 215, generally including the score value and position (touch left, or no touch). The data packet is timestamped, generally to a resolution on the order of microseconds, by a hardware clock or coordinated universal time (UTC) synchronization. A rule is applied, and the rule code is entered in the record (e.g., FIE-SABRE-ROW-2024-v3). An audit identifier is generated and is unique for each event. The audit identifier is immutable. A session binding identifier is also generated for each session, including data for each competitor and each of any weapons used. Any failover flags are also entered into the record. A cryptographic hash is generated for each decision and applied to the record. The record includes each of the score value, timestamp, applied rule code, audit identifier, session binding identifier, and failover indicator flag. The decision record is then transmitted to the cloud archive, AR display, mobile application, and any governance audit.

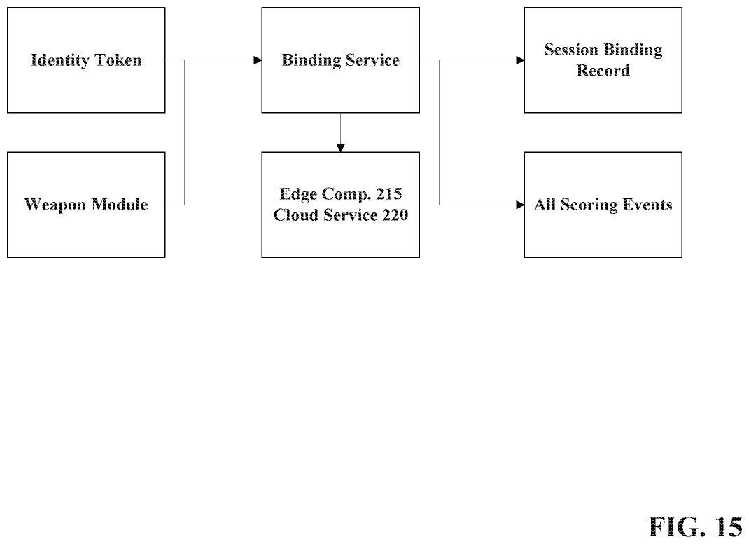

FIG. 15 illustrates an example method for pre-bout binding of metadata to a player and weapon used in a bout. An identity token is generated with any of an RFID tag, QR code, or digital pairing for an athlete. The identity token is linked to any identification number or code assigned to the player by FIE or any sporting association. A weapon module is also assigned based on unique advice identification and assigned bout strip. The identifiers are assigned and interpreted by a binding service, such as an RFID or QR code scanner that reads the identifier and performs a session handshake upon validating the scan. Upon completion of the handshake, the player and weapon data are transmitted to the edge computer 215 and cloud service 220. The player and weapon data are then entered into a session binding record and into all scoring events having the session-binding identification. The session binding record includes the athlete ID, weapon user ID, bout ID, strip ID, and timestamp of the binding.

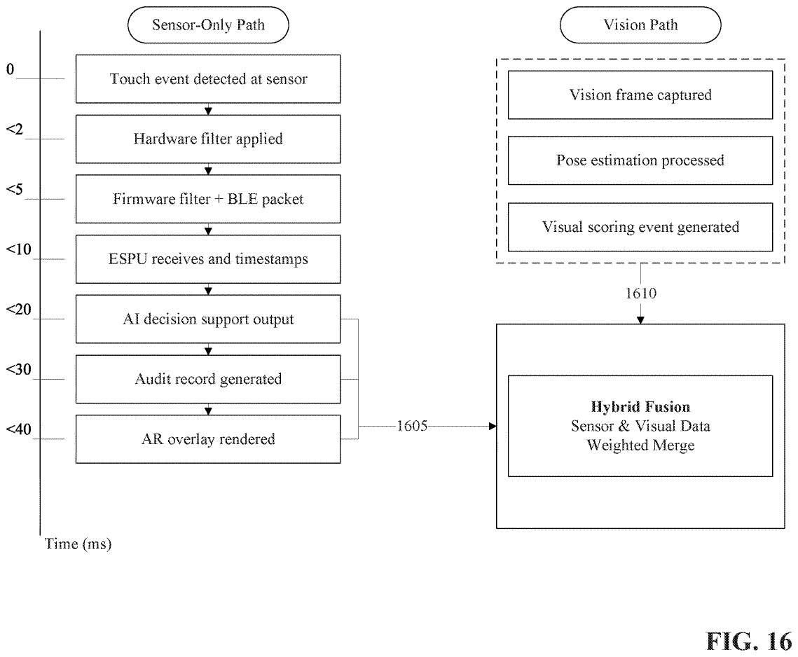

FIG. 16 illustrates an example end-to-end event flow and latency sequence from sensor touch detection to augmented reality renderings. Two data paths are provided: a sensor-only data path 1605 and a vision path 1610, which uses visual data captured by the plurality of cameras 225. According to the example of FIG. 16, additive latency values for each step on the sensor-only path 1605 are given, with total latency from touch event detected to augmented reality overlay rendered being less than 40 milliseconds. The latency from sensor event to output by the artificial intelligence resource 230 is generally below 30 milliseconds.

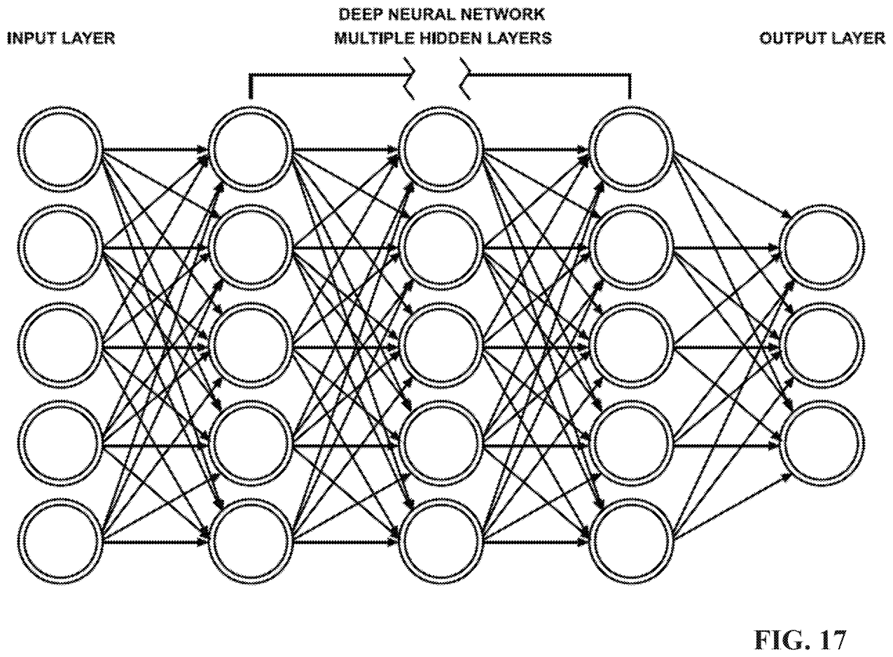

FIG. 17 shows an exemplary deep neural network.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of node layers, comprising an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires”, or activates the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

According to some exemplary embodiments, deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input-output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

With respect to FIG. 17, according to some exemplary embodiments, the system produces an output, which in turn produces an outcome, which in turn produces an input. In some embodiments, the output may become the input.

Deep Neural Networks, such as the one exemplified in FIG. 17, can be used to support artificial intelligence methods and systems, including Large Language Models, for the embodiments described herein.

While various embodiments have been described above, it should be understood that the embodiments have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the technology as defined by the appended claims. Thus, the breadth and scope of a preferred embodiment should not be limited by any of the above-described exemplary embodiments.

What is claimed is:

1. A system for artificial intelligence-assisted scoring, adjudication, and visualization for a sporting event, the system comprising:
a plurality of sensors, each of the plurality of sensors coupled to a transmitter and further coupled to a competitor's uniform, body, or handheld implement;
a plurality of cameras configured to capture visual data from the sporting event;
an edge computer communicatively coupled to an artificial intelligence resource, the edge computer configured to classify and log a scoring event by:
receiving the sensor data as a first data packet from the plurality of sensors and verifying from the sensor data that a scoring event has occurred;
receiving the visual data as a second data packet from the plurality of cameras upon the verification that the scoring event has occurred;
timestamping the first and second data packets and correlating the timestamped data packets to determine a time of a scoring event;
executing discipline-specific scoring logic on the timestamped data packets; and
transmitting the timestamped data packets to the artificial intelligence resource, the artificial intelligence resource configured to generate a scoring decision and support output comprising a machine-readable output data packet transmitted to at least one display device coupled to the edge computer, the output data packet including a confidence score, a feature attribution trace, and a rule-code identifier; and
a visualization system comprising the at least one display device and further comprising an augmented reality resource, the augmented reality resource configured to generate an augmented reality overlay and transmit the augmented reality overlay to the at least one display device.

2. The system of claim 1, further comprising a legacy scoring system communicatively coupled to the edge computer and configured to receive an updated score for a bout upon the logging of the scoring event.

3. The system of claim 1, the artificial intelligence resource further configured to generate a structured analysis file upon the logging of the scoring event, the structured analysis file comprising a human-readable summary of the scoring event, the confidence score, the feature attribution trace, and the rule-code identifier.

4. The system of claim 1, the generating of the augmented reality overlay being conditioned upon the verification that the scoring event has occurred, the verification further comprising:
a scoring accuracy being above a defined threshold, the threshold being determined from a minimum number of scored bouts; and
latency performance being within pre-defined system specifications.

5. The system of claim 1, wherein the plurality of sensors, the plurality of cameras, the edge computer, the artificial intelligence resource, the augmented reality resource, and the at least one display device are communicatively coupled by way of a wireless communication system configured to transmit the data packets, the timestamped data packets, and the output data packets using at least one of: BLE 5.3, radio-frequency (RF) signaling, UWB, or Wi-Fi 6 protocols, and further configured to activate a fallback pathway in response to detecting a packet loss rate exceeding a defined threshold on a primary pathway.

6. The system of claim 1, the edge computer further:
applying multi-layer validation to the timestamped data packets, the multi-layer validation comprising hardware filtering, firmware filtering, and algorithmic filtering modules configured to reduce false-positive and false-negative scoring events; and
logging detected invalid events for calibration feedback.

7. The system of claim 1, further comprising a competitor-implement binding mechanism configured to associate a specific competitor's identity with a specific implement and sensor module coupled to the specific implement, the competitor-implement binding mechanism comprising a competitor-implement identifier.

8. The system of claim 7, the competitor-implement binding mechanism comprising any of: a radiofrequency identification token, a QR code scan, and a secure digital pairing handshake.

9. The system of claim 7, the artificial intelligence resource further configured to generate an auditable bout decision record comprising a field for: a score value, a score timestamp, an applied rule reference, a unique audit identifier, the competitor-implement identifier, and a failover indicator flag set when a fallback pathway was used.

10. The system of claim 9, further comprising a cryptographic hash for each of the fields in the auditable bout decision record.

11. The system of claim 1, the augmented reality overlay comprising a visual playback of the bout with an overlaid trace of any of: implement trajectory, timing window, implement contact with a competitor's body or uniform, off-target contact indicator, and competitor's bodily movement.

12. The system of claim 11, the augmented reality overlay being generated at least in part by the artificial intelligence resource to allow for three-dimensional rotation and reflection of the visual playback.

13. The system of claim 1, further comprising an umpire remote control coupled by a wireless network to the edge computer, the umpire remote control configured to override a scoring decision by the artificial intelligence resource.

14. A method for artificial intelligence-assisted scoring, adjudication, and visualization for a sporting event, the method comprising:
receiving a first data packet by an edge computer coupled to an artificial intelligence resource, from a plurality of sensors, each of the plurality of sensors coupled to a transmitter and further coupled to a competitor's uniform, body, or handheld implement;
verifying from the first data packet that a scoring event has occurred;
receiving, by the edge computer, a second data packet from a plurality of cameras configured to capture visual data from the sporting event, the second data packet being received upon the verification that the scoring event has occurred;
timestamping each data packet of the first data packet and the second data packet and correlating the timestamped data packets to determine a time of an event;
executing discipline-specific scoring logic on the timestamped data packets;
transmitting the timestamped data packets to the artificial intelligence resource, the artificial intelligence resource configured to generate a scoring decision support output comprising a machine-readable output data packet transmitted to at least one display device coupled to the edge computer, the output data packet including a confidence score, a feature attribution trace, and a rule-code identifier; and
generating an augmented reality overlay on a visualization system comprising the at least one display device and further comprising an augmented reality resource.

15. The method of claim 14, further comprising receiving the logging of the scoring event by a legacy scoring system communicatively coupled to the edge computer.

16. The method of claim 14, the artificial intelligence resource further configured to generate a structured analysis file upon the logging of the scoring event, the structured analysis file comprising a human-readable summary of the scoring event, the confidence score, the feature attribution trace, and the rule-code identifier.

17. The method of claim 14, further comprising applying, by the edge computer, multi-layer validation to the timestamped data packets, the multi-layer validation comprising hardware filtering, firmware filtering, and algorithmic filtering modules configured to reduce false-positive and false-negative scoring events; and
logging detected invalid events for calibration feedback.

18. The method of claim 14, further comprising generating, by the artificial intelligence resource, an auditable bout decision record comprising a field for: a score value, a score timestamp, an applied rule reference, a unique audit identifier, a competitor-implement identifier, and a failover indicator flag set when a fallback pathway was used.

19. The method of claim 14, further comprising synchronizing the auditable bout decision record to a cloud synchronization module.

20. The method of claim 14, the artificial intelligence resource being trained on labeled datasets comprising synchronized video, sensor telemetry, and referee annotations that classify attack, parry, riposte, and counterattack.

21. The method of claim 14, further comprising queueing the output data packet for human review if the output data packet includes a confidence score below a predetermined confidence threshold.

22. A method for assembly of a system for artificial intelligence-assisted scoring, adjudication, and visualization for a sporting event, the method comprising:
communicatively coupling a plurality of sensors to one or more transmitters and further coupling each of the plurality of sensors to a competitor's uniform, body, or handheld implement;
communicatively coupling a plurality of cameras configured to capture visual data from the sporting event to a network, and further coupling the plurality of sensors to the network;
communicatively coupling the plurality of sensors and the plurality of cameras to an edge computer, the edge computer communicatively coupled to an artificial intelligence resource, the edge computer configured to determine that a scoring event has occurred by:
receiving a first data packet from a plurality of sensors each of the plurality of sensors coupled to a transmitter and further coupled to a competitor's uniform, body, or handheld implement;
verifying from the first data packet that a scoring event has occurred;
receiving a second data packet from a plurality of cameras configured to capture visual data from the sporting event, the second data packet being received upon the verification that the scoring event has occurred;
timestamping the first and second data packets and correlating the timestamped data packets to determine a time of an event;
executing discipline-specific scoring logic on the timestamped data packets; and
transmitting the timestamped data packets to the artificial intelligence resource, the artificial intelligence resource configured to generate a scoring decision support output comprising a machine-readable output data packet transmitted to at least one display device coupled to the edge computer, the output data packet including a confidence score, a feature attribution trace, and a rule-code identifier; and
communicatively coupling the edge computer to a visualization system comprising the at least one display device and an augmented reality resource, the augmented reality resource configured to generate an augmented reality overlay and transmit the augmented reality overlay to the at least one display device.

23. The method of claim 22, further comprising training the artificial intelligence resource on labeled datasets comprising synchronized video, sensor telemetry, and referee annotations classifying attack, parry, riposte, and counterattack.

24. The method of claim 22, further comprising coupling an umpire remote to the edge computer by way of the network, the umpire remote configured to override a scoring decision by the artificial intelligence resource.

25. The method of claim 24, further comprising deploying the system in conjunction with at least one component of a legacy scoring system for the sporting event, the legacy scoring system configured to receive an updated score for a bout upon the logging of the scoring event.
